(19) United States
(12) Patent Application Publication
(10) Pub. No.: US 2005/0177712 A1
(43) Pub. Date: Aug. 11, 2005

(54) Directly writing data to a memory

(76) Inventor: Zafer Kadi, Tempe, AZ (US)

Correspondence Address: TROP PRUNER & HU, PC, 8554 KATY FREEWAY, SUITE 100, HOUSTON, TX, 77024, US

(21) Appl. No.: 10/741,859

(22) Filed: Dec. 19, 2003

(51) Int. Cl. H04L 9/00

(52) U.S. Cl. 713/150; 713/320

(57) ABSTRACT

In one embodiment, the present invention includes a method to store data received at a wireless device from a remote location to a buffer via a security device within the wireless device. In certain embodiments, the data may be secure data sent using a remote direct memory access protocol.

### BACKGROUND

Communications between different systems may occur in a variety of manners. For example, data communication between a first system, such as a data center server, and a remote computer system typically requires memory copy operations at both the server and computer level, increasing data transfer time and consuming significant processor and memory resources.

A recent communication scheme called remote direct memory accessing (RDMA) in accordance with the Remote Direct Memory Access Protocol over TCP/IP Networks, Version 1.0 specification (published October 2002), enables removal of certain data copy operations and reduces resource usage by allowing one computer to directly place information in another computer's memory with minimal processor demands. However, such a protocol requires heavy traffic between servers, and real time requirements of data traffic can cause many interrupts to the processor on the receiving side and reduce its efficiency. Furthermore, components to support RDMA transfers on the receiving side have high buffer requirements and use significant power resources. Also, there can be security concerns with data transfer using RDMA protocols, and such protocols are not suited to occasionally connected computing devices. Thus a need exists to provide for data transfer between systems that consume lower power, and that is compatible with occasional computing models and improved security.

### BRIEF DESCRIPTION OF THE DRAWINGS

FIG. 1 is a flow diagram of a method in accordance with one embodiment of the present invention.

FIG. 2 is a block diagram of a wireless device in accordance with one embodiment of the present invention.

FIG. 3 is a block diagram of a connection between a remote server and a wireless device in accordance with one embodiment of the present invention.

### DETAILED DESCRIPTION

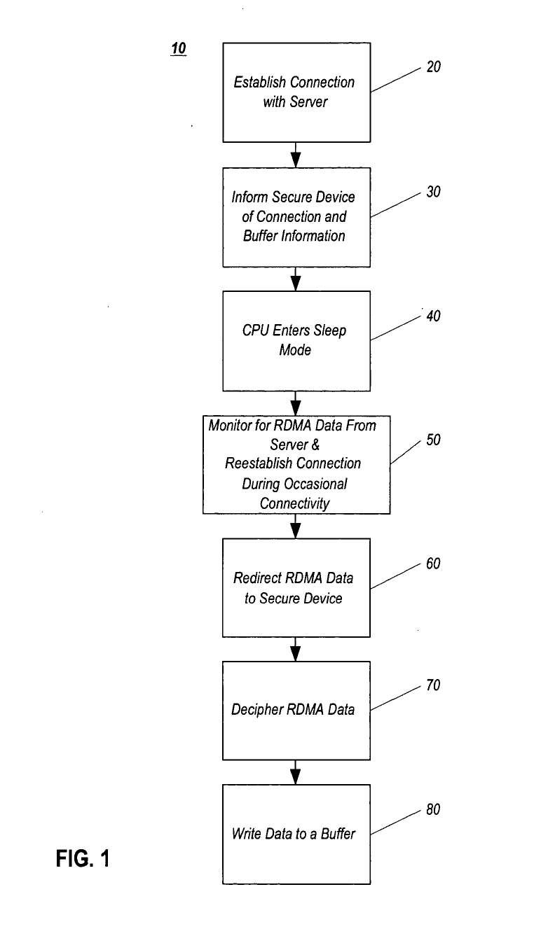

Referring to FIG. 1, shown is a flow diagram of a method in accordance with one embodiment of the present invention. As shown in FIG. 1, method 10 may begin by establishing a connection with a server (block 20). For example, in one embodiment a wireless device such as a cellular phone (e.g., of a 2.5 generation (G) or later variety), a personal digital assistant (PDA), a laptop computer or the like, may initiate a connection with a remote server. As an example, the remote server may be a secure server of a corporate network to which the user of the wireless device has access. Alternately, the server may be a secure server of a content provider such that the wireless device may be able to receive various digital content, such as movies, music, copyrighted materials and the like. In one embodiment, a main (or applications) processor of the wireless device may establish the connection.

Next, a secure device (also herein termed a “security device”) associated with the wireless device may be informed of the connection and buffer information (block 30). In one embodiment, the main processor (e.g., a central processing unit (CPU)) may provide a security device (e.g., a trusted module such as a fixed token) with information regarding the connection with the remote server. Furthermore, the main processor may inform the secure device of buffer information. Such buffer information may include a location in a memory (either volatile or nonvolatile) of the wireless device at which data to be downloaded is to be stored. As used herein, the terms “information” and “data” may be used interchangeably, and may refer to both data and instructions.

In such manner, the main processor of the wireless device can pass off responsibility for receiving and storing the data to the secure device and other components of the wireless device. Thus in certain embodiments, the main processor may enter a low power mode, such as a sleep mode (block 40). In so doing, power resources of the wireless device may be conserved. In other embodiments, the main processor need not enter a sleep mode, but may perform application processes without being interrupted by data transfer activities.

Still referring to FIG. 1, the secure device may monitor for data being received from the remote server (block 50). In one embodiment, the data may be provided according to a RDMA protocol. In embodiments operating with occasional connectivity, a connection to the remote server may be re-established before monitoring for the data.

When the secure device becomes aware of the receipt of such data from the remote server, the data may be redirected to the secure device (block 60). For example, in one embodiment, data may be received in the wireless device via a network interface card (NIC) or other such wireless interface. In accordance with an embodiment of the present invention, such NIC or wireless interface need not include a buffer for temporarily storing received data, as such data may be immediately redirected to the secure device, saving power and cost.

Next, in an embodiment in which downloaded data is sent securely (e.g., is encrypted), the data may be deciphered using the secure device (block 70). After such deciphering of the data, the secure device may write the data to a buffer (block 80). Specifically, the secure device may write the data to the specified location in a desired memory, as previously instructed by the main processor of the wireless device.

In certain embodiments, protocols for direct memory access transfer from a source system may be in accordance with known protocols, such as the RDMA protocol. However, on the destination system, a lighter (i.e., more limited) version of such a protocol may be used to allow for communication with the source and to configure the destination for receipt of data transfer, but to limit (and/or even prevent) usage of a main processor of the destination system during data transfer and storage.

In one embodiment, such a light RDMA protocol may be implemented on an applications subsystem of the destination system and may perform tasks such as buffer allocation in memory and handshaking operations, for example. As an example, an applications processor may dedicate a memory region, which may be a non-volatile memory such as a flash memory (e.g., NOR-based or NAND-based flash), or a volatile memory such as a synchronous dynamic random access memory (SDRAM) or a static RAM (SRAM) as a buffer location. Further, the applications processor may set the security device to redirect the traffic to the memory region directly as a secure light RDMA engine.

Embodiments may be implemented in a program. As such, these embodiments may be stored on a storage medium having stored thereon instructions which can be used to program a system to perform the embodiments. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs), erasable programmable read-only memories (EPROMs), electrically erasable programmable read-only memories (EEPROMs), flash memories, a phase change or ferroelectric memory, a silicon-oxide-nitride-oxide-silicon (SONOS) memory, magnetic or optical cards, or any type of media suitable for storing electronic instructions. Similarly, embodiments may be implemented as software modules executed by a programmable control device, such as a computer processor or a custom designed state machine.

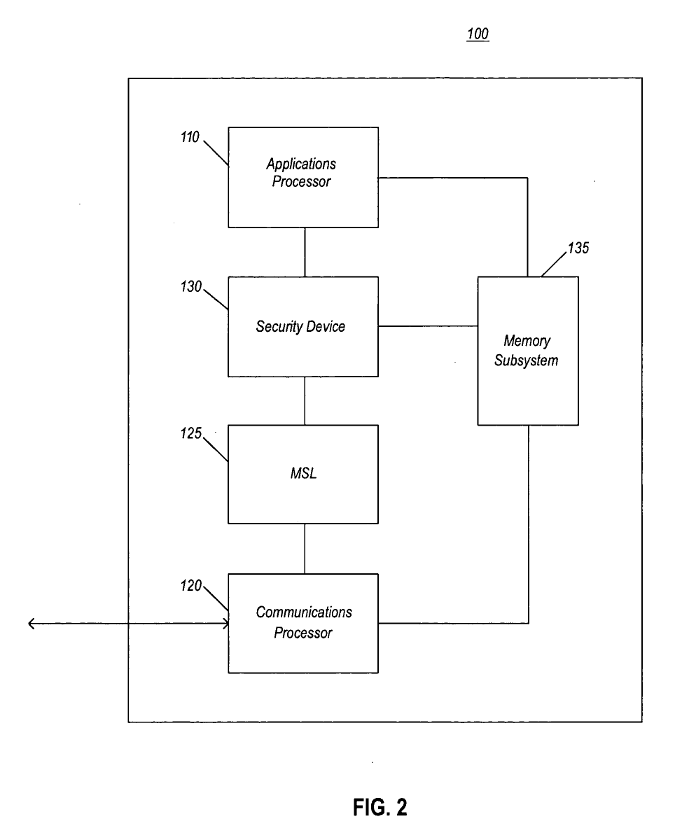

Referring now to FIG. 2, shown is a block diagram of a wireless device in accordance with one embodiment of the present invention. As shown in FIG. 2, wireless device 100 includes an applications processor 110. Such an applications processor may be used to execute various applications such as data processing functions, manipulation of digital content and the like. In one embodiment, applications processor 110 may be a 32-bit processor, such as an XSCALE™ processor, available from Intel Corporation, Santa Clara, Calif.

As shown in FIG. 2, wireless device 100 also includes a communications processor 120. Such communications processor 120 may be primarily responsible for driving communications between wireless device 100 and remote sources. As shown, a bidirectional wireless link to communicate data may be present. In one embodiment, communications processor 120 may be a processor in accordance with a micro signal architecture.

As shown further in FIG. 2, applications processor 110 and communications processor 120 may be coupled via a link 125, such as a mobile scalable link (MSL), which may be formed of a plurality of gating devices to scalably transfer data between the processors.

Also shown in FIG. 2, a security device 130 may be coupled between MSL 125 and applications processor 110. While such a security device may vary in different embodiments, in one embodiment, security device 130 may be a trusted module, such as a fixed token that may have various smart card capabilities, including encryption/decryption functions, keying and the like. Alternately, the security device may be integrated into one or more components of a wireless device, such as a network interface card, a communications processor, another digital signal processor, a memory (such as a flash memory) having security features or the like. For example, the security device may be a subscriber identity module (SIM).

As further shown in FIG. 2, various components of the wireless device 100 may be coupled to a memory subsystem 135. Memory subsystem 135 may include both volatile and non-volatile memory, such as SRAM, DRAM, flash memories, and the like. While shown as including different components, it is to be understood that a wireless device in accordance with an embodiment of the present invention may include a single component, such as a semiconductor device that performs the functions of the different components discussed above.

It is to be understood that communications processor 120 may include various functionalities including wireless communication with external sources. For example, communications processor 120 may include a wireless interface (which in turn may have an antenna which, in various embodiments, may be a dipole antenna, helical antenna, global system for wireless communication (GSM) or another such antenna). In certain embodiments, the wireless interface may support General Packet Radio Services (GPRS) or another data service. GPRS may be used by wireless devices such as cellular phones of a 2.5G or later configuration.

Other embodiments of the present invention may be implemented in a circuit switched network such as used by 2G technologies, a Personal Communications System (PCS) network, a Universal Wireless Telecommunications System (UMTS), or UMTS Telecommunications Radio Access (UTRA) network or other communication schemes, such as a BLUETOOTH™ protocol or an infrared protocol (such as Infrared Data Association (IrDA)). While discussed in FIG. 2 as being a wireless device, in other embodiments, light RDMA protocols may be used in connection with desktop, server or other non-wireless devices.

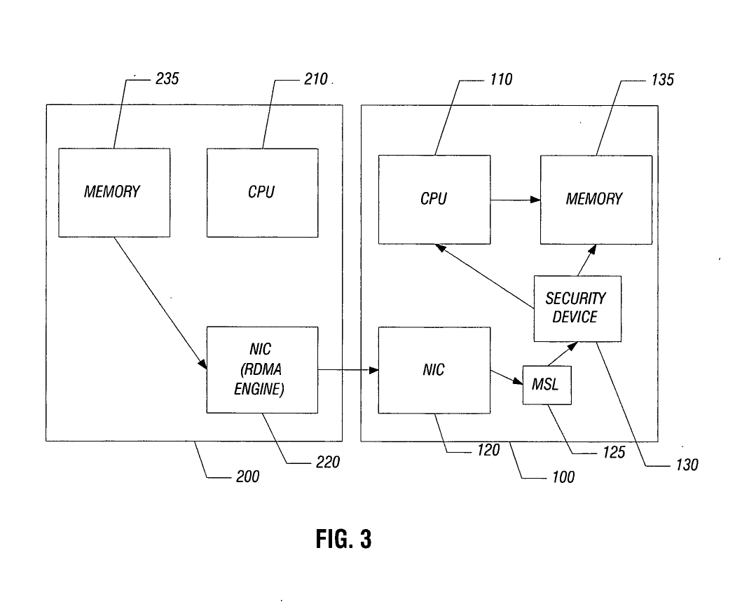

Referring now to FIG. 3, shown is a block diagram of a connection between a remote server and a wireless device in accordance with one embodiment of the present invention. As shown in FIG. 3, a remote server 200, which may be a secure server includes a central processing unit (CPU) 210, a network interface card 220 that may include a RDMA engine and a memory buffer 235. Memory buffer 235, which may be one or more of any desired type of storage medium, may include secure data desired to be downloaded by wireless device 100. In one embodiment, server 200 may implement RDMA protocols such that CPU 210 provides a source address, a destination address and a data length to NIC 220. NIC 220 may then obtain the desired data from memory 235 according to the source address.

Then, a wireless connection may be established between server 200 and wireless device 100. While the nature of the wireless communication may vary in different embodiments, certain embodiments may use a wireless local area network (WLAN) protocol, such as an Institute of Electrical and Electronic Engineers (IEEE) std. 802.11a, b or g protocol, a BLUETOOTH™ connection, a wireless code division multiple access (WCDMA), a wireless wide area network (WWAN), ultrawide-band or other such protocol. Alternately, the devices may be coupled together using wires, for example, using a wide area network (WAN).

The data to be downloaded may be transferred from NIC 220 to NIC 120, which may be a portion of a communications processor of wireless device 100. In one embodiment, security device 130 may be monitoring for the receipt of such data and, based on information previously received from applications processor 110, secure device 130 may redirect the incoming data directly through a mobile scalable link 125 into security device 130, where it may be decrypted and redirected to a desired location in memory 135.

In certain embodiments, for a server to push data into a destination buffer, the connection may be restricted to secure servers, avoiding some of the overhead of RDMA when needed. In one such embodiment, a secure server identification and security and keys (symmetric or/and asymmetric) may be stored in the security device. For example, the security device may pre-store security information for dedicated servers from which it frequently may download data. Such security information may be stored in any secure media, as an example a SIM card. In such manner, handshaking during connection and reconnection for occasional connectivity devices may be reduced.

In one embodiment, the applications processor may send a request to a server indicating that a buffer is allocated and requesting data. In other embodiments, the server may initiate communications with the wireless device. Each server may be allocated a unique server buffer identification. The unique server buffer identification may be permanently assigned to a secure server identification in the security device, thus reducing handshaking in certain embodiments. Such a 1:1 correspondence between source server and buffer location may provide further security protection. Embodiments may also implement security measures, including hardware enforcement of application buffer boundaries, and an additional layer of security via a data layer encrypted with preloaded keys using cryptographic algorithms.

During operation, the security device may monitor traffic from a NIC or a communications subsystem and divert the traffic when packets of RDMA or other direct memory access data is received. In such embodiments, packets may be deciphered with a server key and be inserted/written into the previously assigned buffer location. In an embodiment that includes a scalable link, the link may be RDMA aware, in order to choose the correct addresses of destination and source. In such manner, diverted traffic may be processed through the security device and stored/written directly at the buffer memory location previously assigned by the applications processor. Accordingly, communications and applications subsystems may be separated, freeing the applications processor for data processing.

In certain embodiments, the applications processor and many other components of the wireless device (e.g., a display, memory, and the like) may be turned off, and a limited subset of components, such as the scalable link, the security device, and the buffer to be written to, may be on, allowing the communications subsystem to download data at reduced power consumption.

As an example, a movie or audio stream (e.g., a MPEG (Motion Pictures Expert Group)-1 Layer 3 (MP3)) may be downloaded to the security device, and be played later. Via the security features discussed above, (e.g., secure keys), such a downloading service may be limited to subscribers only. Further, embodiments may be used by occasional computing devices, such that when an available connection is established, the data transfer may be initiated (or continue) with minimum applications processor involvement.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
storing data received at a wireless device from a remote location to a buffer via a security device within the wireless device.

2. The method of claim 1, further comprising receiving the data while an applications processor of the wireless device is in a low power mode.

3. The method of claim 2, further comprising providing connection and buffer information to the security device from the applications processor.

4. The method of claim 2, further comprising performing a handshake between the applications processor and the remote location to receive remote direct memory access protocol information.

5. The method of claim 1, further comprising decrypting the data at the security device using a key provided by the remote location.

6. The method of claim 1, further comprising receiving the data while the wireless device is in a low power mode.

7. The method of claim 1, further comprising receiving remote direct memory access data while an applications processor of the wireless device is in a sleep mode.

8. An apparatus comprising:
a security device of a wireless device to directly store information received from a remote location to a buffer.

9. The apparatus of claim 8, further comprising an applications processor coupled to the security device.

10. The apparatus of claim 9, wherein the applications processor is coupled to provide connection and buffer information to the security device.

11. The apparatus of claim 10, wherein the buffer information identifies a location in the buffer.

12. The apparatus of claim 8, further comprising a network interface card coupled to the security device to divert the information from the remote location to the security device.

13. The apparatus of claim 12, further comprising a scalable link coupled between the network interface card and the security device.

14. The apparatus of claim 8, wherein the security device comprises a trusted module having at least one encryption mechanism.

15. The apparatus of claim 8, wherein the buffer comprises a flash memory.

16. The apparatus of claim 8, wherein the information comprises remote direct memory access data.

17. A method comprising:
directly storing data received from a remote source into a storage medium of a wireless device.

18. The method of claim 17, further comprising receiving and storing the data while the wireless device is in a low power mode.

19. The method of claim 17, further comprising receiving and storing the data while an applications processor of the wireless device is in a sleep mode.

20. The method of claim 17, further comprising using a security device within the wireless device to store the data to the storage medium.

21. The method of claim 20, further comprising pre-storing security information corresponding to the remote source in the security device.

22. The method of claim 19, wherein the applications processor provides an address in the storage medium to a security device before entering the sleep mode.

23. A system comprising:
a security device of a wireless device to directly store data received from a remote location to a buffer; and
a wireless interface coupled to the security device.

24. The system of claim 23, further comprising an applications processor coupled to the security device.

25. The system of claim 24, wherein the applications processor is coupled to provide connection and buffer information to the security device.

26. The system of claim 23, wherein the wireless interface comprises an antenna.

27. An article comprising a machine readable storage medium containing instructions that if executed enable a system to:
directly store information received from a remote source into a storage medium of a wireless device.

28. The article of claim 27, further comprising instructions that if executed enable the system to decrypt the information before storing the information.

29. The article of claim 27, further comprising instructions that if executed enable the system to use a security device within the wireless device to store the information to the storage medium.
